(19) United States
(12) Patent Application Publication
(10) Pub. No.: US 2020/0101751 A1
(43) Pub. Date: Apr. 2, 2020

(54) IMAGE FORMING APPARATUS AND IMAGE FORMING APPARATUS BODY

(71) Applicants: Munekazu HIRATA, Tokyo (JP); Takayuki ANDOH, Kanagawa (JP); Satoshi NARAI, Kanagawa (JP); Kunihiko NISHIOKA, Kanagawa (JP); Masatoshi ISHIDA, Kanagawa (JP); Yohei OSANAI, Kanagawa (JP); Tomoya FUJII, Kanagawa (JP); Masashi OTA, Kanagawa (JP)

(72) Inventors: Munekazu HIRATA, Tokyo (JP); Takayuki ANDOH, Kanagawa (JP); Satoshi NARAI, Kanagawa (JP); Kunihiko NISHIOKA, Kanagawa (JP); Masatoshi ISHIDA, Kanagawa (JP); Yohei OSANAI, Kanagawa (JP); Tomoya FUJII, Kanagawa (JP); Masashi OTA, Kanagawa (JP)

(73) Assignee: Ricoh Company, Ltd., Tokyo (JP)

(21) Appl. No.: 16/558,421

(22) Filed: Sep. 3, 2019

(30) Foreign Application Priority Data
Sep. 28, 2018 (JP) 2018-185191

(51) Int. Cl. B41J 2/175; B41J 2/045; B41J 2/14

(52) U.S. Cl. CPC B41J 2/17543; B41J 2/14201; B41J 2/04581

(57) ABSTRACT

An image forming apparatus includes a recording device configured to record an image on a recording medium and an apparatus body configured to house the recording device. The image forming apparatus further includes an attachment unit configured to be removably mounted in the apparatus body; a protection target disposed downstream, in a mounting direction of the attachment unit, from a mounting position of the attachment unit in the apparatus body; and a contact portion at least a part of which is positioned upstream from the protection target in the mounting direction.

### CROSS-REFERENCE TO RELATED APPLICATION

This patent application is based on and claims priority pursuant to 35 U.S.C. § 119(a) to Japanese Patent Application No. 2018-185191, filed on Sep. 28, 2018, in the Japan Patent Office, the entire disclosure of which is hereby incorporated by reference herein.

### BACKGROUND

### Technical Field

The present disclosure generally relates to an image forming apparatus and an image forming apparatus body.

### Description of the Related Art

There are mobile image forming apparatuses including a recording device to record an image on a recording medium, an apparatus body that houses the recording device.

For example, the recording device is an inkjet head and removably attached to the apparatus body.

### SUMMARY

An embodiment of this disclosure provides an image forming apparatus including an apparatus body. The apparatus body includes a recording device configured to record an image on a recording medium. The image forming apparatus includes an attachment unit configured to be removably mounted in the apparatus body.

The apparatus body includes a protection target disposed downstream, in a mounting direction of the attachment unit, from a mounting position of the attachment unit in the apparatus body. The apparatus body also includes a contact portion at least a part of which is positioned upstream from the protection target in the mounting direction.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross-sectional side view of a handheld printer according to an embodiment in a state in an ink cartridge is mounted in the handheld printer;

FIG. 2 is an exterior perspective view illustrating the handheld printer, as viewed from above on a rear left side;

FIG. 3 is a bottom view of the handheld printer;

FIG. 4 is a schematic cross-sectional view of the handheld printer as viewed from the left side;

FIG. 5 is an illustration indicating a positional relationship between a hand of a user and the handheld printer being operated by the user;

FIG. 6 is a schematic view illustrating how the handheld printer forms an image on a recording sheet;

FIG. 7 is a block diagram illustrating a part of an electric circuit of the handheld printer;

FIG. 8 is an exterior perspective view illustrating the handheld printer as viewed from above on a front left side;

FIG. 9 is an exterior perspective view of the handheld printer with an upper unit thereof opened;

FIG. 10 is a perspective view illustrating a state of the handheld printer in which an ink cartridge pops up;

FIG. 11 is a perspective view of the handheld printer ith the ink cartridge removed from an apparatus body of the handheld printer;

FIG. 12 is a perspective view illustrating a lower unit of the handheld printer;

FIG. 13 is a top view of the lower unit;

FIG. 14 is a sectional view of the handheld printer hen the ink cartridge is mounted in the handheld printer in a reverse orientation;

FIG. 15 is a perspective view of the ink cartridge, as viewed obliquely from below;

FIG. 16 is a top view of the lower unit of the handheld printer with a region marked by broken lines where a print head faces when the ink cartridge is mounted in the reverse orientation;

FIG. 17 is a sectional view of a handheld printer according to Variation 1 in a state in which an ink cartridge is mounted;

FIG. 18 is a sectional view of the handheld printer according to Variation 1 in a state the ink cartridge is mounted in the reverse orientation;

FIG. 19 is a sectional view of a handheld printer according to Variation 2 in a state in which an ink cartridge is mounted;

FIG. 20 is a sectional view of a handheld printer according to Variation 3 in a state in which an ink cartridge is mounted, as viewed from a side;

FIG. 21 is a sectional view of the handheld printer according to Variation 3 in a state in which the ink cartridge is mounted, as viewed from a front side;

FIG. 22 is a top view of the handheld printer according to Variation 3 in a state in which the ink cartridge is not mounted;

FIG. 23 is a sectional view of the handheld printer according to Variation 3 in a state in which the ink cartridge is mounted in the reverse orientation, as viewed from a side.

The accompanying drawings are intended to depict embodiments of the present invention and should not he interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

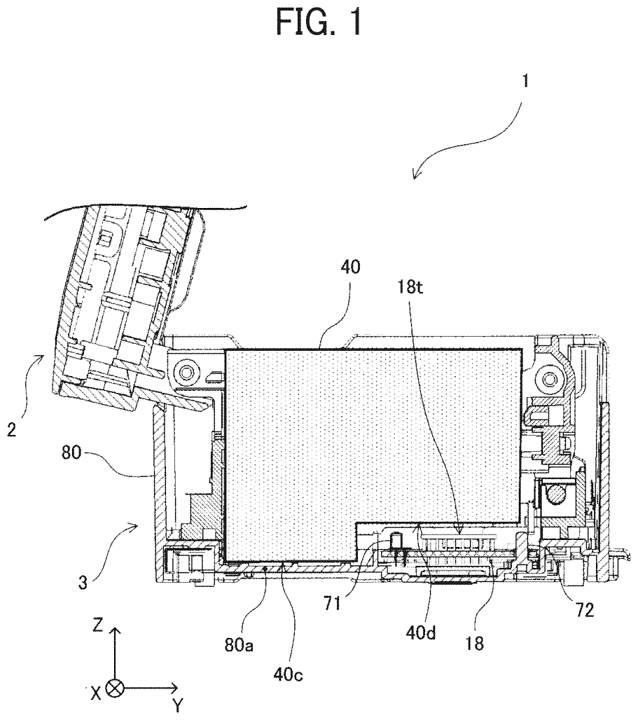

Referring now to the drawings, wherein like reference numerals designate identical or corresponding parts throughout the several views thereof, and particularly to FIG. 1, an image forming apparatus according to an embodiment of this disclosure is described. As used herein, the singular forms “a”, “an”, and “the” are intended to include the plural forms as well, unless the context clearly indicates otherwise.

Descriptions are given below of a handy (or handheld) mobile printer (hereinafter simply referred to as “handheld printer 1”) that is a mobile image forming apparatus, according to an embodiment of the present disclosure. First, a basic configuration of the handheld printer 1 according to the embodiment is described.

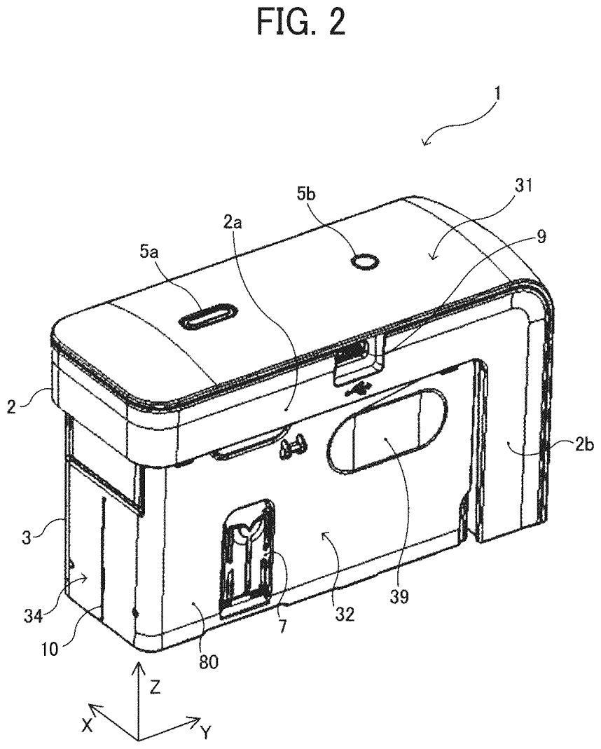

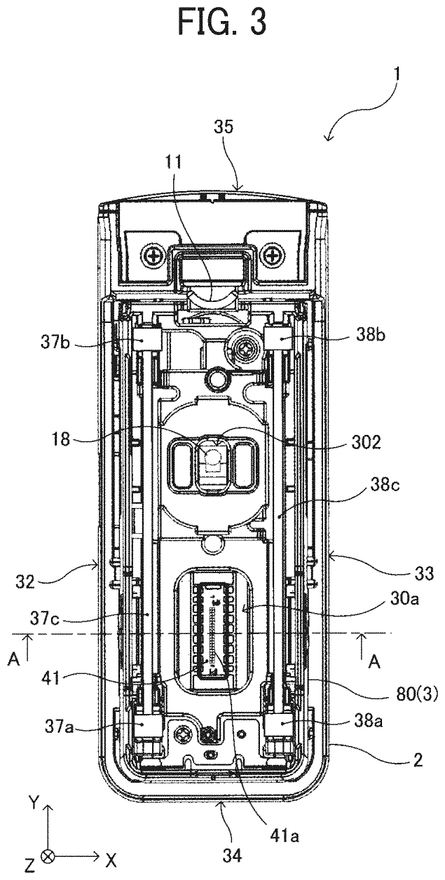

FIG. 2 is an exterior perspective view of the handheld printer 1 as viewed from above the rear left side, and FIG. 3 is a bottom view of the handheld printer 1.

As illustrated in FIG. 2, the handheld printer 1 includes an upper unit 2 and a lower unit 3. The handheld printer 1 as a whole is shaped like a rectangular parallelepiped. The handheld printer 1 has such a length in a scanning direction (that is, a printing direction or an X-axis direction in drawings) that a user can grasp the handheld printer 1 with a palm.

As illustrated in FIG. 2, the lateral direction (a short-side direction) of an apparatus body of the handheld printer 1 is defined as an X-axis direction, and a longitudinal direction of the apparatus body orthogonal to the lateral direction is defined as a Y-axis direction. In printing operation using the handheld printer 1, to linearly print letters or illustrations, the handheld printer 1 is moved in the X-axis direction, which is the scanning direction. Then, the handheld printer 1 is moved in the Y-axis direction to perform line feed.

However, the printing operation using the handheld printer 1 is not limited to the above-described operations. For a case where letters, illustrations, etc. are arranged attractively, the handheld printer 1 can be moved for printing in an oblique direction other than the X-axis direction or along a curved track. In addition, the handheld printer 1 can be moved in a direction other than the Y-axis direction for line feed.

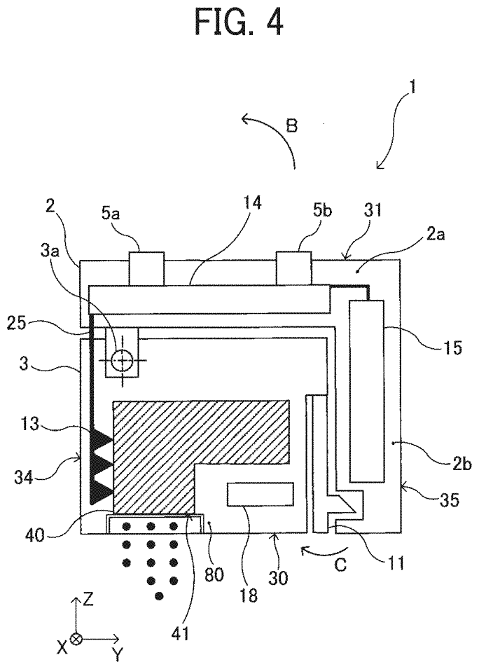

FIG. 4 is a schematic sectional view of the handheld printer 1 as viewed from the left side.

As illustrated in FIG. 4, the upper unit 2 is shaped like a letter “L” and includes a horizontal portion 2a extending in the Y-axis direction and a vertical portion 2b extending in a Z-axis direction. The vertical portion 2b of the upper unit 2 contains a battery 15 as a power source to supply power to components of the handheld printer 1. The horizontal portion 2a includes a control board 14, and a print button 5a and a power button 5b are connected to the control board 14. The power button 5b is a button for powering on and off the handheld printer 1, and the print button 5a is a button for the timing of ink discharge.

The lower unit 3 includes an upper unit rotation shaft 3a to rotatably support the upper unit 2, a position detection sensor 18, a flexible printed circuit (FPC) terminal 13, an upper unit lock claw 11, and a housing 80 that supports these components. The position detection sensor 18 is a photosensor (reflection type) and detects position coordinates and the presence and absence of a print target. Further, the housing 80 of the lower unit 3 contains an ink cartridge 40 (a print head) that includes a print head 41 (a recording device or an image forming device) and an ink tank combined into a single unit, and the ink cartridge 40 is removable from the housing 80. The ink cartridge 40 is configured to discharge ink from the print head 41 for image formation. When the ink cartridge 40 is mounted in the handheld printer 1, the print head 41 is faced down in the vertical direction to discharge ink droplets.

As the upper unit 2 is rotated relative to the lower unit 3 in the direction indicated by arrow B in 4, an opening above the housing 80 of the lower unit 3 is exposed. Then, the ink cartridge 40 disposed therein becomes removable from the housing 80.

In the handheld printer 1 according to the present embodiment, the battery 15 is disposed on the vertical portion 2b of the upper unit 2, and the vertical portion 2b is positioned to cover a front side (on the right in FIG. 4) of the lower unit 3. Thus, the battery 15 is located on the side of a front face 35 of the ink cartridge 40. As a result, the height of the handheld printer 1 is reduced compared with the configuration in which the battery 15, which is relatively heavy, is positioned above the ink cartridge 40. Such placement lowers the gravitational center (gravity center position) of the handheld printer 1, thus preventing the handheld printer 1 from falling over while being moved.

In the scanning direction (X-axis direction), the size (apparatus width) of the handheld printer 1 is slightly wider than the size of the ink cartridge 40. Minimizing the apparatus width can widen the range in which the handheld printer 1 can be moved in the scanning direction on the surface of a recording medium and maximize a recordable range on the surface of the recording medium.

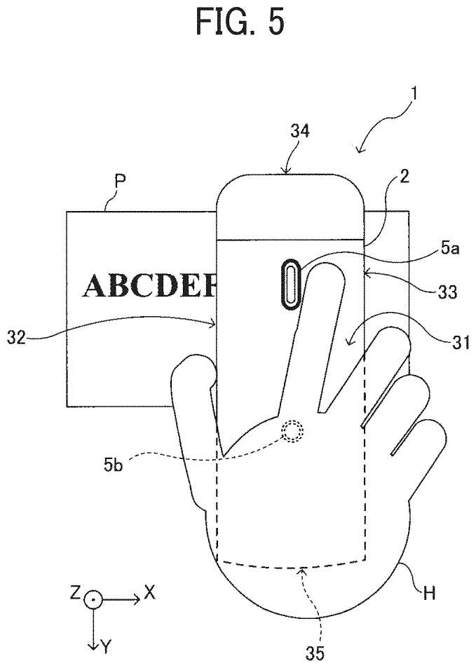

The handheld printer 1 includes a recording face 30 (bottom side) on which the print head 41 of the ink cartridge 40 is disposed and opposed to a recording medium, such as a paper sheet. The handheld printer 1 further includes an upper face 31 on the opposite side of the recording face 30, a left face 32 (See FIG. 5) extending in a direction (Y-axis direction in FIG. 3) orthogonal to the scanning direction of the handheld printer 1, and the like. The handheld printer 1 further includes, for example, a right face 33 (See FIG. 5) extending in the orthogonal direction (Y-axis direction), a rear face 34 extending in the scanning direction (X-axis direction), and the front face 35 extending in the scanning direction. The handheld printer 1 is usually used in such a posture that the recording face 30 is faced vertically down and the upper face 31, which is opposite the recording face 30, is faced vertical up.

The print button 5a and the power button 5b are disposed within an outer edge (within a frame) of the upper face 31 (See FIG. 2). The left face 32 of the upper unit 2 includes a universal serial bus (USB) connection port 9 (See FIG. 2). The USB connection port 9 is a port for connecting a USB cable. The handheld printer 1 is provided with the rechargeable battery 15 mounted therein. The battery 15 can be charged with electric power supplied thereto from an external power supply via the USB cable connected to the USB connection port 9.

As illustrated in FIGS. 2 and 4, the L-shaped upper unit 2 is disposed to cover the upper face 31 and the front face 35 of the lower unit 3. The upper unit 2 is wider (longer in the X-axis direction) than the lower unit 3.

FIG. 5 is an illustration indicating a positional relationship between a hand H of a user and the handheld printer 1 being operated by the user.

As illustrated in FIG. 5, to move the handheld printer 1 for image formation on the recording sheet P in the scanning direction (X-axis direction, lateral in FIG. 5), the user holds the upper unit 2. Since the upper unit 2 is wider than the lower unit 3, the user can easily hold the upper unit 2 with the hand, and the vertical portion 2b thereof can serve as a container for the battery 15. Further, as illustrated in FIG. 2, the left face 32 and the right face 33 of the lower unit 3 respectively include grip portions 39. The grip portions 39 are disposed, respectively, at positions where fingers (usually a thumb and a middle finger or a ring finger) of the hand H hold the upper unit 2 when the user uses the handheld printer 1. The user can put his or her fingers on the respective grip portion 39 on the left face 32 and the right face 33 with the handheld printer 1 sandwiched between these fingers, thereby holding the handheld printer 1 stably.

The user can hold the power button 5b for a while to switch on and off the power of the handheld printer 1. With the power turned on, the control board 14 mounted in the upper unit 2 of the handheld printer 1 can acquire image information with an external device, e.g., a smartphone, by wireless communication using Bluetooth (registered trademark) communication or the like.

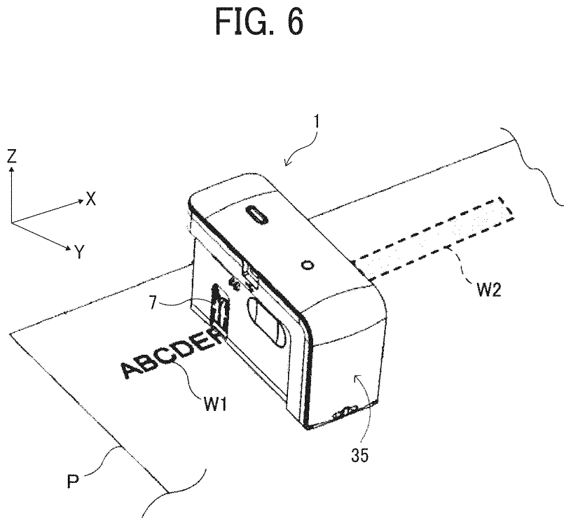

FIG. 6 is a perspective view illustrating how the handheld printer 1 forms an image on the recording sheet P.

After the image data is acquired, the handheld printer 1 is placed on the recording sheet P with the recording face 30 opposed to the surface of the recording sheet P. Then, the user presses the print button 5a once and moves the handheld printer 1 in the scanning direction as illustrated in FIG. 6, thus forming an image on the recording sheet P. As illustrated in FIG. 6, in the image formation by the handheld printer 1, the user can check an already printed portion W1 and a planned print area W2 in which printing is to be made while moving the handheld printer 1.

The handheld printer 1 is capable of printing and recording on the recording sheet P freehand, thus achieving both the convenience in mobility and the sheet handling capability.

The user can adjust the position of the handheld printer 1 so that the character string to be printed comes to the planned print area W2 which is a desired position for printing on the recording sheet P. In addition, with sub-scanning guides 7 that are print position indicators in the Y-axis direction, the user can operate the handheld printer 1 while checking the position printed by the handheld printer 1, so that printing can be performed more accurately at the user's desired position. Further, the handheld printer 1 detects, with the position detection sensor 18, positions in the X-axis and the Y-axis directions, thereby detecting the position of the handheld printer 1. Therefore, when the handheld printer 1 is located at a given position, the handheld printer 1 can print a desired character string or a desired image.

The handheld printer 1 can form an image on the surface of the recording sheet P both when the user moves the handheld printer 1 (manual scanning) toward one side (right side in FIG. 6) in the scanning direction (X-axis direction) and when the user moves the handheld printer 1 to the opposite side (left side in FIG. 6) in the scanning direction. The handheld printer 1 can be configured to discharge ink from the ink cartridge 40 continuously, after the user once presses and releases the print button 5a or discharge ink from the ink cartridge 40 only while the user presses the print button 5a.

The recording medium is not limited to paper, such as recording paper, but includes, for example, overhead projector (OHP) sheets, cloth, cardboards, packaging containers, glass, and substrates.

As illustrated in FIG. 3, the face of the lower unit 3 (a bottom side of the housing 80) serving as the recording face 30 includes a discharge opening 30a. From the discharge opening 30a, the print head 41 of the ink cartridge 40 mounted in the lower unit 3 is exposed to the outside. The print head 41 of the ink cartridge 40 includes a plurality of discharge nozzles 41a and is capable of discharging ink droplets separately from the respective discharge nozzles 41a as piezoelectric elements are driven,

The width of an image recording area of the print head 41, that is, the length of the image in the direction (Y-axis direction) orthogonal to the scanning direction, is the distance between the discharge nozzles 41a located at both ends of the plurality of the discharge nozzles 41a in the Y-axis direction.

The ink discharged from the discharge nozzles 41a of the print head 41 passes through the discharge opening 30a and reaches the recording sheet P, thus forming an image thereon.

As a driving source to discharge ink, the ink cartridge 40 can employ, for example, an electromechanical transducer element (e.g, a piezoelectric actuator) including a lamination-type piezoelectric element or a thin-film-type piezoelectric element. Example configurations of the driving source further include an electrothermal transducer element, such as a heat element, and an electrostatic actuator including a diaphragm and opposed electrodes.

The ink cartridge 40 has a so-called inkjet mechanism to discharge liquid or droplets such as ink to perform recording. Any inkjet mechanism mountable in the handheld printer 1 can be used. In the handheld printer 1 according to the present embodiment, the inkjet mechanism corresponds to the print head 41 that records an image on the recording sheet P, and the print head 41 is stored in the housing 80 of the lower unit 3.

The “liquid” discharged from the discharge nozzles 41a of the print head 41 is not particularly limited as long as the liquid has a viscosity and a surface tension that can be discharged from the discharge nozzles 41a. However, it is preferable that the viscosity is 30 mPa·s or less under ordinary temperature and pressure or by heating or cooling. Specifically, the term “ink (liquid)” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, a surface treatment liquid, liquid for forming components of electronic elements or light-emitting elements, liquid for forming resist patterns of electronic circuits or a material solution for three-dimensional fabrication.

As illustrated in FIG. 3, inside the outer edge of the recording face 30, the position detection sensor 18 as a detector is disposed. The position detection sensor 18 detects, in a non-contact manner, the position of the handheld printer 1 on the recording sheet P. The bottom side of the housing 80 serving as the recording face 30 is provided with a detection opening 302 to expose a detection portion of the position detection sensor 18.

In the case of a contact type sensor using a rotary encoder or the like, the sensor needs to be in contact with the print surface, and a detection error due to the contact state is likely to occur. Specifically, when the detection portion of the contact type sensor separates from or slips on the print surface, the actual moving direction and travel distance differ from the moving direction and travel distance calculated based on the detection result, which becomes a detection error. By contrast, the accuracy of detection of the moving direction and the travel distance is higher when an optical sensor as the position detection sensor 18 detects the print surface in a non-contact manner.

Further, as illustrated in FIG. 3, inside the outer edge of the recording face 30, a first left roller 37a, a second left roller 37b, a first right roller 38a, and a second right roller 38b are disposed and rotatably attached to the housing 80. The first left roller 37a and the second left roller 37b are secured to a left rotation shaft 37c, and the left rotation shaft 37c is rotatably held by the housing 80. Similarly, the first right roller 38a and the second right roller 38b are secured to a right rotation shaft 38c, and the right rotation shaft 38c is rotatably held by the housing 80.

When the handheld printer 1 is moved in the scanning direction by the user, the four rollers (37a, 37b, 38a, and 38b) in contact with the surface of the recording sheet rotate like tires. Owing to such rollers, the user can advance the handheld printer 1 straight in the scanning direction. Further, when the handheld printer 1 is moved straight in the scanning direction, only the four rollers (37a, 37b, 38a, and 38b) provided on the handheld printer 1 are in contact with the surface of the recording sheet P or the surface of the table on which the recording sheet P is placed. The recording face 30 is not in contact with the surface of the recording sheet P. Therefore, the user can move the handheld printer 1 straight along the scanning direction while keeping a constant distance between the print head 41 of the ink cartridge 40 and the surface of the recording sheet P. Thus, a desired high-quality image can be formed. That is, the four rollers guide the movement of the handheld printer tin the scanning direction and assist the linear movement in the scanning direction.

The position detection sensor 18 is a sensor to detect the distance to the surface of the recording sheet P, the surface state (for example, asperities) of the recording sheet P, and the distance by which the handheld printer 1 has traveled. A similar sensor, for example, an optical mouse (a pointing device) of a personal computer can be used for the position detection sensor 18. The position detection sensor 18 irradiates, with light, a place (e.g., the recording sheet P) where the position detection sensor 18 is placed and reads the state of the place as a “pattern”. The position detection sensor 18 sequentially detects how the “pattern” moves relative to the movement of the position detection sensor 18, to calculate the amount of movement. As the position detection sensor 18, any sensor other than an optical sensor such as an ultrasonic sensor can be used as long as a change in position with respect to the recording sheet P can be detected in a non-contact manner. The position detection device of mobile image forming apparatuses, such as the handheld printer 1, to which aspects of the present disclosure can be applied is not limited to a contactless sensor such as the position detection sensor 18, but can be a contact-type sensor using a rotary encoder or the like.

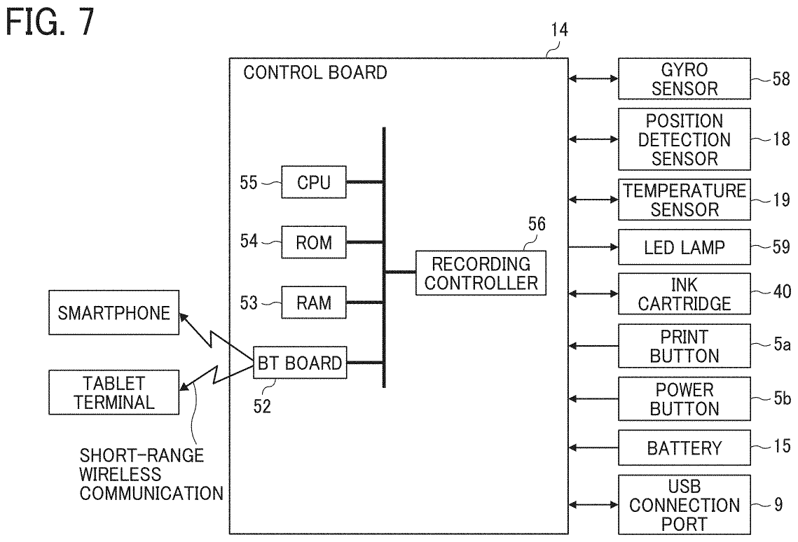

FIG. 7 is a block diagram illustrating a portion of an electric circuit of the handheld printer 1.

The control board 14 includes a central processing unit (CPU) 55 that performs various arithmetic processing and program execution, a Bluetooth (registered trademark, hereinafter “BT”) board 52 for short-range wireless communication using Bluetooth, a random access memory (RAM) 53 that temporarily stores data, a read-only memory (ROM) 54, and a recording controller 56. The control board 14 is secured at a position on the inner side of the USB connection port 9 in a hollow space of the upper unit 2.

The BT board 52 performs data communication by short-range wireless communication with an external device, such as a smartphone or a tablet terminal. The ROM 54 stores, for example, firmware for hardware control of the handheld printer 1 and drive waveform data of the ink cartridge 40. The recording controller 56 executes data processing for driving the ink cartridge 40 and generates drive waveforms.

The control board 14 is electrically connected to a gyro sensor 58, the position detection sensor 18, a temperature sensor 19, a light emitting diode (LED) lamp 59, the ink cartridge 40, the print button 5a, the power button 5b, the battery 15, and the like. The gyro sensor 58 detects a tilt and a rotation angle of the handheld printer 1 and transmits the result of detection to the control board 14. The LED lamp 59 is disposed inside an exterior cover made of a light-transmissive material of the print button 5a and makes the print button 5a luminous.

When the power button 5b is pressed to turn on the power of the handheld printer 1, power is supplied to each module. The CPU 55 initiates startup according to the program stored in the ROM 54 and mounts the program and each data in the RAM 53. When data of an image to be formed is received from an external device by short-range wireless communication, the recording controller 56 generates a drive waveform corresponding to the image data. The discharge of ink from the ink cartridge 40 is controlled to form an image corresponding to the position on the surface of the recording sheet P detected by the position detection sensor 18.

The position detection sensor 18 detects the direction and the speed of movement of the handheld printer 1 and the distance by which the handheld printer 1 has traveled. The discharge amount of ink and the discharge position of ink are adjusted based on the detection result of the position detection sensor 18, thereby printing a target image. Further, the discharge start position can be adjusted using the sub-scanning guides 7 provided on the left face 32 and the right face 33 of the housing 80 and a main scanning guide 10 provided on the rear face 34 of the housing 80. Specifically, the main scanning guide 10 is used to align the position of the handheld printer 1 on the recording sheet P in the main scanning direction (X-axis direction in FIG. 2), and the sub-scanning guides 7 are used to align the position of the handheld printer 1 on the recording sheet P in the sub-scanning direction (Y-axis direction). Thus, the discharge start position can be adjusted.

In response to acquisition of image data via short-range wireless communication from an external device, the control board 14 causes the LED lamp 59 to blink so that the light-transmissive print button 5a, which transmits light, becomes luminous and blinks. Seeing such a blinking light, the user knows the completion of the acquisition of the image data. Then, the user places the handheld printer 1 on the recording sheet P and presses the print button 5a.

Meanwhile, as the control board 14 starts blinking of the LEI) lamp 59, the control board 14 waits for pressing of the print button 5a. When the print button 5a is pressed, the control board 14 causes the LED lamp 59 to keep emitting the light so that the print button 5a continuously emits the light. Seeing the continuous light emission, the user starts moving the handheld printer 1 (manual scanning) in the scanning direction.

The user who has finished moving the handheld printer 1 (manual scanning) again presses the print button 5a. With such an operation, the control board 14 turns off the LED lamp 59 and stops lighting of the print button 5a. Or, there may be a case where the user does not press the print button 5a but picks up the handheld printer 1 from the recording sheet P and places the handheld printer 1, for example, on a table or mounts the handheld printer 1 in a cover that covers the recording face 30. In these cases, the position detection sensor 18 becomes incapable of detecting the position when the handheld printer 1 is picked up from the recording sheet P. At the timing when the position detection sensor 18 no longer detects the position, the control board 14 turns off the LED lamp 59 and stops lighting of the print button 5a. Seeing the stop of the lighting, the user knows that the operation of the handheld printer 1 for printing has ended.

In the handheld printer 1 according to the present embodiment, it is not necessary to keep pushing the print button 5a while the user moves the handheld printer 1 (manual scanning). When the print button 5a is pressed and released prior to the moving of the handheld printer 1, printing operation is continued until a predetermined timing. Examples of the predetermined timing include a timing when the image formation based on the detection result by the position detection sensor 18 ends, a timing when the print button 5a is pressed again, and a timing when the position detection sensor 18 becomes incapable of position detection.

When the image formation is not performed, such as after the image formation is completed, a capping unit that covers the recording face 30 of the handheld printer 1 is attached to the handheld printer 1. Thereby, drying of the ink in the discharge nozzles 41a can be prevented.

Next, a description is given of the shape of the upper unit 2 of the handheld printer 1 according to the present embodiment.

The handheld printer 1 includes the lower unit 3 and the upper unit 2. The lower unit 3 is an apparatus main body and serves as an attachment unit mount to contain the print head 41. The upper unit 2 serves as a cover to open and close the face of the lower unit 3 (an opening of the upper side of the housing 80) opposite the recording face 30, which is the location of the print head 41 in the lower unit 3.

As illustrated in FIGS. 2 and 4, the upper unit 2 is “L-shaped” and includes the horizontal portion 2a and the vertical portion 2b. The horizontal portion 2a covers the upper side of the housing 80 opposite to the bottom side of the housing 80 of the lower unit 3 on which the print head 41 is disposed. The vertical portion 2b extends downward to the recording face 30 side from the horizontal portion 2a. The vertical portion 2b covers at least a portion of the side face (the left face 32, the right face 33, the rear face 34, or the front face 35) of the lower unit 3 between the bottom side and the upper side of the lower unit 3.

In the handheld printer 1 according to the present embodiment, the upper unit 2 as the cover is L-shaped and includes the vertical portion 2b extending from the horizontal portion 2a to the side (downside) of the recording face 30. Owing to the vertical portion 2b, not only the horizontal portion 2a but also the vertical portion 2b can be touched with the hand and the force for opening or closing can be applied to both thereof, in order to open or close the upper unit 2 as the cover. Therefore, the user can hold one or both of the horizontal portion 2a, which is on the side opposite the recording face 30 in the handheld printer 1, and the vertical portion 2b, which is on a lateral side of the recording face 30, to open or close the upper unit 2 as the cover. That is, the user can hold one or both of the two portions to which the opening or closing force can be easily applied. Thus, the ease of operation in opening and closing the upper unit 2 can be improved.

In the handheld printer 1 according to the present embodiment, as illustrated in FIG. 4, the battery 15 is disposed in the vertical portion 2b which is a portion of the L-shaped upper unit 2 and extends in the vertical direction of the handheld printer 1. As a result, the relatively heavy battery 15 can be disposed on a lateral side of the lower unit 3, not above the lower unit 3. Further, the longitudinal direction of the battery 15, the specific gravity of which is relatively large, can be in the height direction of the handheld printer 1. Therefore, the gravitational center of the entire apparatus can be lowered. This feature can attain the effect that the handheld printer 1 does not easily fall and the usability is improved.

Improving the usability is advantageous in preventing the deterioration of the quality of printed images caused by the impaired usability of the handheld printer 1.

The position of the inkjet head (the print position) in X-Y plane parallel to the surface of the recording sheet P is preferably disposed on the rear face 34 in the longitudinal direction (Y-axis direction) of the handheld printer 1 from the viewpoint of the user's operability. The reason is that the margin at the top of the print is reduced when the print position is disposed on the rear face 34 of the handheld printer 1 in the longitudinal direction, as the bottom of the print is printed on the front side of the user. Generally, the print is made with the top alignment, and it is preferable that the top margin is smaller than the bottom margin. Therefore, the position of the inkjet head (the print position) is preferably disposed on the rear face 34 of the handheld printer 1 in the longitudinal direction.

The mobile image forming apparatus is preferably provided with a lock mechanism (e.g., the upper unit lock claw 11 according to the present embodiment) to lock the cover to the main body so that the cover is not opened or closed during the image forming operation. However, if the cover is disposed only on the upper side of the main body, an operated portion (e.g., a lever) of the lock mechanism is disposed on the lateral side (the right side, the left side, the front side, and the rear side) or the upper side of the main body. In this structure, however, the operated portion of the lock mechanism is in the reach of the user's hand in a state in which the printer is placed on the sheet, and it is possible that, during the image forming operation, the user erroneously operates the lock mechanism and releases the lock of the cover.

In the handheld printer 1 according to the present embodiment, the lower end of the vertical portion 2b forms a portion of the recording face 30, and the position_{;} in the direction from the upper face 31 toward the recording face 30, of the lower end portion of the vertical portion 2b is the same as the bottom side of the housing 80. The bottom side of the housing 80 includes the discharge opening 30a. The upper unit lock claw 11 as a locking mechanism is positioned on the recording face 30 on which the discharge opening 30a of the handheld printer 1 is disposed. The upper unit lock claw 11 is an operated portion to be operated to release the lock of the upper unit 2 from the lower unit 3.

The recording face 30 provided with the discharge opening 30a is the bottom side of the handheld printer 1, and the recording face 30 faces a paper surface in a state in which the handheld printer 1 is placed on the paper sheet. Accordingly, the user can be prevented from touching the upper unit lock claw 11 on the recording face 30. This arrangement can prevent the user from erroneously operating the upper unit lock claw 11 during an image forming operation (during printing operation) and prevent the upper unit 2 from being released due to the erroneous operation.

Arranging the upper unit lock claw 11 on the lower face of the handheld printer 1 is advantageous in preventing the user from touching the upper unit lock claw 11, not only during a printing operation, but also at an unintended timing, such as when the user touches the handheld printer 1 without aim. This can reduce the possibility that the upper unit 2 may be released at an unintended timing.

The configuration to prevent the user from erroneously operating the lock mechanism during the image forming operation is not limited to the configuration in which the lower end of the vertical portion 2b is at the same position as the lower face of the housing 80. As long as the shape includes the vertical portion 2b, the locking mechanism can be disposed on the lower face serving as the lower end of the vertical portion 2b or the lateral side face of the housing 80 adjacent to the lower face, thereby preventing the user from touching the locking mechanism with the vertical portion 2b. By inhibiting the user from touching the lock mechanism, this configuration can prevent the user from erroneously operating the lock mechanism during the image forming operation.

In the handheld printer 1 according to the present embodiment, the grip portion 39 is provided on each of the left face 32 and the right face 33. It is desirable that the grip portions 39 are disposed at the gravitational center on the Y-Z plane of the handheld printer 1. Specifically, the gravitational center on the Y-Z plane of the handheld printer 1 is disposed so as to be positioned inside the grip portions 39 on the Y-Z plane. The following effect can be attained by providing the grip portions 39, in which the user puts his or her fingers to grip the handheld printer 1, in the vicinity of the gravitational center of the handheld printer 1. The user can be guided to grip the vicinity of the gravitational center of the handheld printer 1 so that the user can smoothly operate the handheld printer 1.

Next, the operation of taking out the ink cartridge 40 from the handheld printer 1 according to the present embodiment will be described.

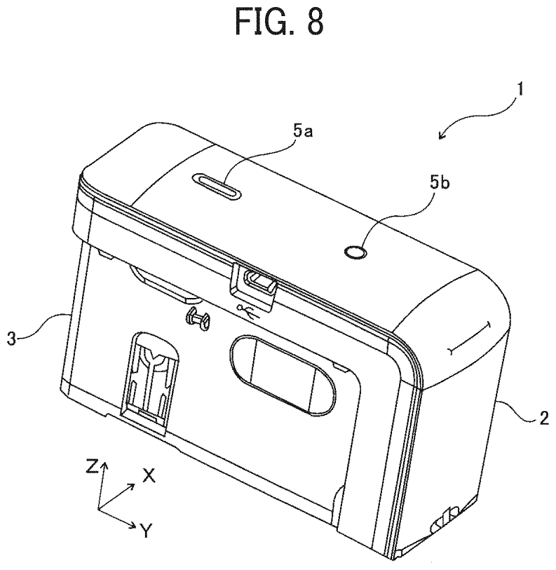

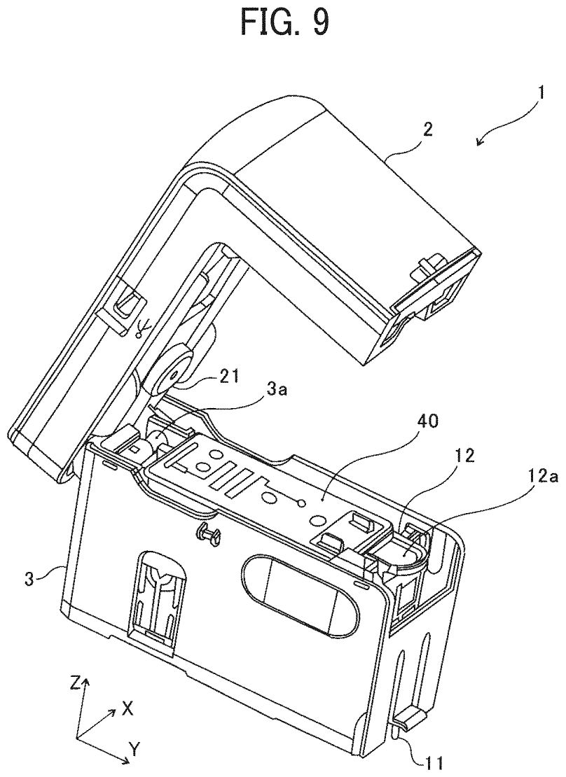

FIG. 8 is an exterior perspective view of the handheld printer 1, as viewed from the upper left on the front side. FIG. 9 is a perspective view of the handheld printer 1 in a state in which the upper unit 2 is rotated in the direction indicated by arrow B illustrated in FIG. 4, with respect to the lower unit 3, from the state illustrated in FIG. 8.

As illustrated in FIGS. 3 and 4, the upper unit lock claw 11 is disposed in the vicinity of the boundary between the lower unit 3 (the bottom side of the housing 80) and the upper unit 2 (the bottom side of the vertical portion 2b) on the recording face 30 of the handheld printer 1. The upper unit lock claw 11 is operated to move in the direction indicated by arrow C in FIG. 4, to release the lock of the upper unit 2 from the lower unit 3. In such a released state, the upper unit 2 is rotated relative to the lower unit 3, around the upper unit rotation shaft 3a in the direction indicated by arrow B in FIG. 4. Then, the upper unit 2 is open relative to the lower unit 3, as illustrated in FIG. 9,

The ink cartridge 40 is replaceable and removable by opening the upper unit 2 which is an open/close cover.

As illustrated in FIG. 9, when the upper unit 2 is in the open state, the ink cartridge 40 and a cartridge attaching and detaching mechanism 12 are exposed. Also, as illustrated in FIG. 9, on the inner face of the upper unit 2, a head pressing member 21 to press and hold the ink cartridge 40 mounted in the lower unit 3 is secured.

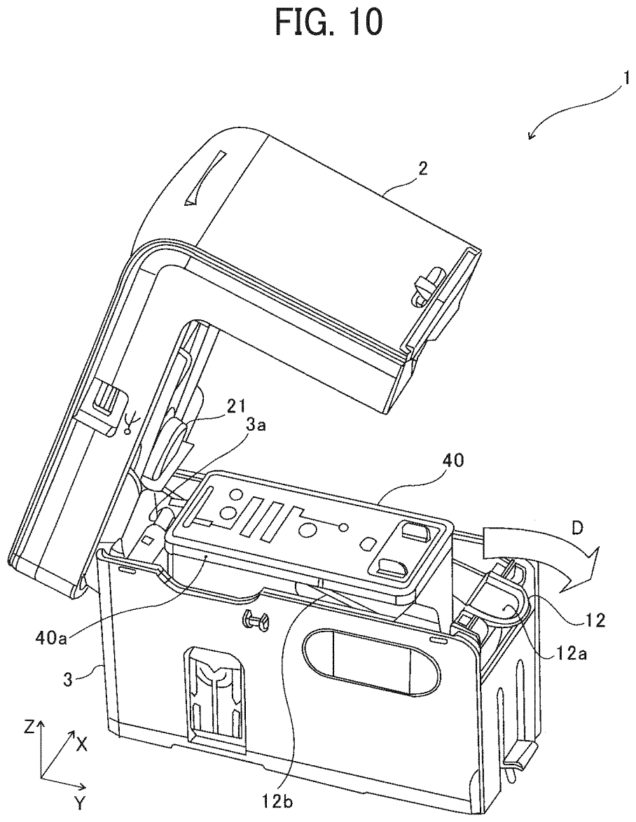

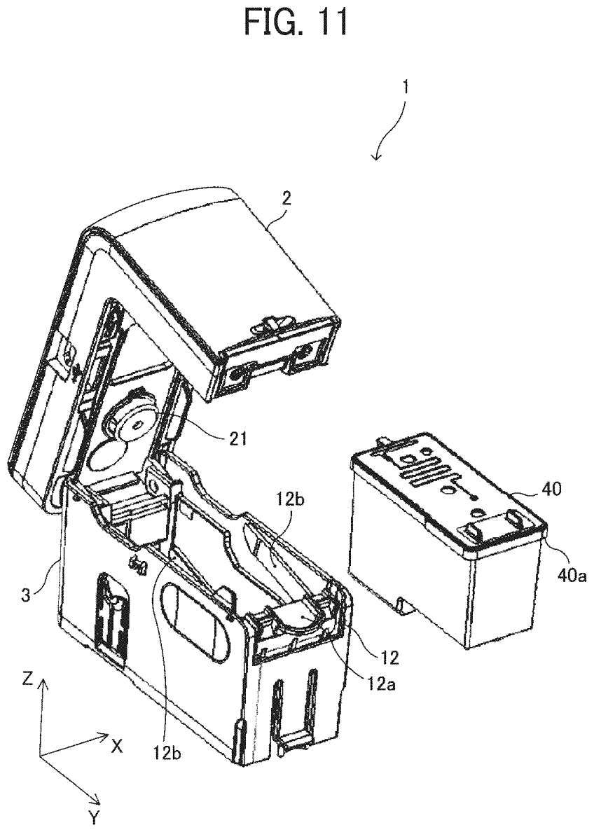

FIG. 10 is a perspective view of the handheld printer 1 in a state in which the ink cartridge 40 is pushed up by operating an operated portion 12a (e.g., a lever or a handle) of the cartridge attaching and detaching mechanism 12 of the handheld printer 1 in the state illustrated in FIG. 9, FIG. 11 is a perspective view of the handheld printer 1 with the ink cartridge 40 removed from the main body of the handheld printer 1.

As the operated portion 12a of the cartridge attaching and detaching mechanism 12 is pulled to the front face side as indicated by arrow D in FIG. 10, the cartridge attaching and detaching mechanism 12 rotates, centering on a rotation shaft near a lower end, in the direction of arrow D. By this rotation, a push-up lever 12b of the cartridge attaching and detaching mechanism 12 pushes up a flange portion 40a of the ink cartridge 40 from the state illustrated in FIG. 9. Then, the ink cartridge 40 pops up from the state illustrated in FIG. 9 to the state illustrated in FIG. 10. Thus, the ink cartridge 40 can be removed from the main body of the handheld printer 1, as illustrated in FIG. 11.

In the handheld printer 1 according to the present embodiment, only the upper unit 2 is the cover that is opened to mount the ink cartridge 40 in the handheld printer 1 or remove the ink cartridge 40 therefrom. Therefore, compared with the structure including a plurality of covers, the apparatus structure can be simple, and the apparatus can be compact. Additionally, since the number of components to be opened by the user is smaller, the number of operation steps can be reduced in attachment and removal of the ink cartridge 40. Thus, the usability can be improved.

FIG. 12 is a perspective view of the lower unit 3 of the handheld printer 1 in the state in which the ink cartridge 40 is removed from the handheld printer 1 and the upper unit 2 is also removed, as viewed obliquely above on the front side. As illustrated in FIG. 12, a housing bottom face 80a forming a bottom face of the housing 80 includes the discharge opening 30a. Furthermore, the housing bottom face 80a includes a sensor protection film 180 which covers the upper side of the position detection sensor 18 fixed to the upper surface of the housing bottom face 80a.

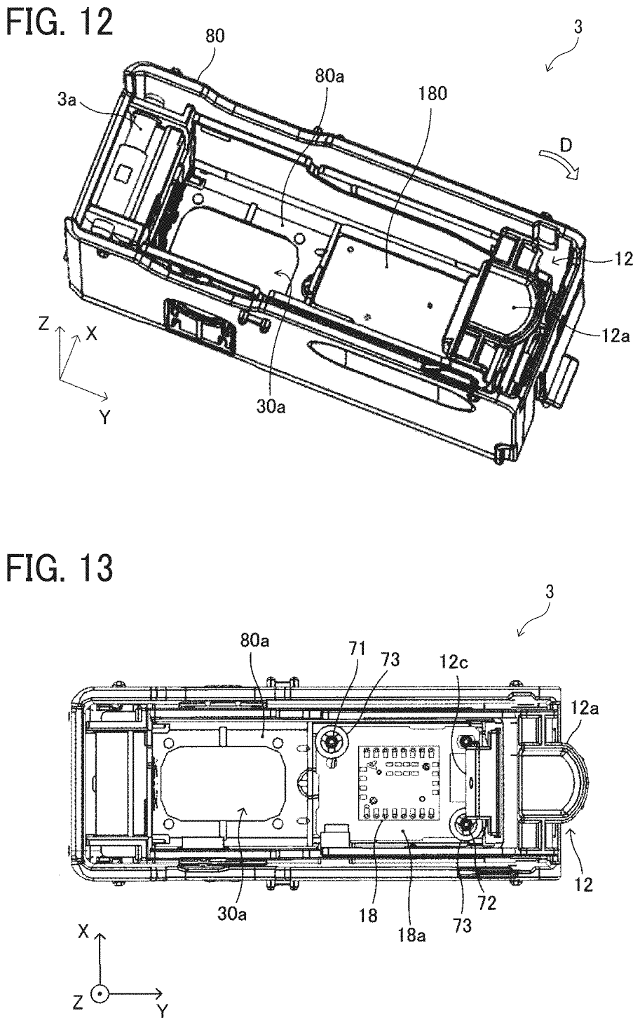

FIG. 13 is a top view of only the lower unit 3 and is an explanatory view of a state in which the cartridge attaching and detaching mechanism 12 is moved in the direction of arrow D in FIG. 12 and the sensor protection film 180 is removed.

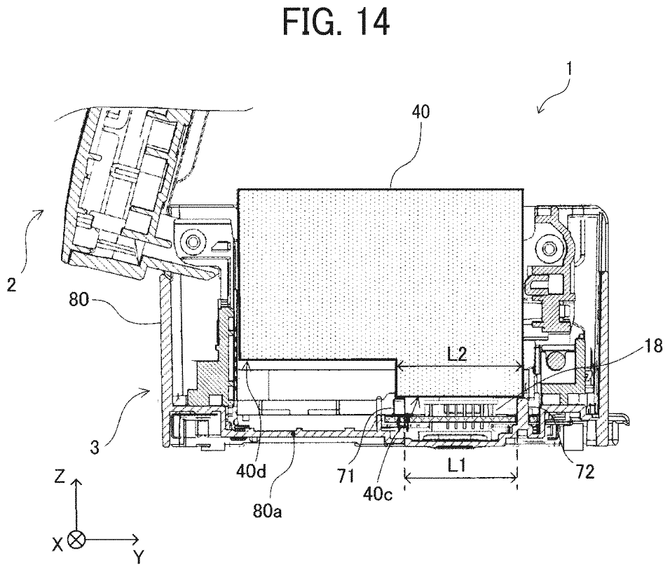

FIG. 14 is a sectional view of the handheld printer 1 in a state in which the upper unit 2 is open and the ink cartridge 40 is mounted.

As illustrated in FIGS. 1 and 13, the housing bottom face 80a forming a bottom face of the housing 80 includes a first sensor position restriction projection 71 and a second sensor position restriction projection 72 (hereinafter also collectively “sensor position restriction projections 71 and 72”) that project upward. The position detection sensor 18 is positioned in the horizontal direction (X-Y plane) of the housing 80 by the first sensor position restriction projection 71 and the second sensor position restriction projection 72.

Specifically, a sensor substrate 18a to which the position detection sensor 18 is fixed is provided with a plurality of positioning holes. The position detection sensor 18 is attached from above the housing 80 such that the first sensor position restriction projection 71 and the second sensor position restriction projection 72 as a part of the housing 80 respectively pass through two of the plurality of the positioning holes. As a result, the position detection sensor 18 is positioned in the horizontal direction.

Furthermore, the position detection sensor 18 attached from above abuts the upper side of the housing bottom face 80a of the housing 80. In this state, speed nuts 73 as vertical position restriction members are attached to the first sensor position restriction projection 71 and the second sensor position restriction projection 72. As a result, the upward movement of the position detection sensor 18 is restricted. Then, the position detection sensor 18 interposed between the speed nuts 73 and the housing bottom face 80a is positioned in the vertical direction.

The configuration to determine the vertical position of the position detection sensor 18 is not limited to the configuration in which retaining rings such as the speed nuts 73 are used. For example, in a state where the first sensor position restriction projection 71 and the second sensor position restriction projection 72 engage with the holes of the sensor substrate 18a, an adhesive is applied to the engaging portions. As a result, the vertical movement of the position detection sensor 18 can be restricted. Further, the sensor substrate 18a may be attached to the housing 80 by fitting, to restrict movement in the vertical direction.

As illustrated in Ha 1, the ink cartridge 40 includes a lower side protrusion 40c and a lower side recess 40d on the bottom of the ink cartridge 40, on a downstream side of a mounting direction (top to bottom in FIG. 1) of the ink cartridge 40 into the apparatus body. The lower side protrusion 40c protrudes in the mounting direction. The lower side recess 40d is recessed to the upstream side (upper side in FIG. 1) in the mounting direction from the lower side protrusion 40c. The position detection sensor 18 is disposed at a position below the lower side recess 40d of the ink cartridge 40 when the ink cartridge 40 is mounted. By disposing the position detection sensor 18 in the space below the lower side recess 40d formed by a step with the lower side protrusion 40c, the position detection sensor 18 can be positioned adjacent to the ink cartridge 40. Thus, the size of the handheld printer 1 can be compact.

FIG. 14 is a sectional view of the handheld printer 1 in a state in which the upper unit 2 is open and the ink cartridge 40 is mounted with the front-back orientation reversed.

The ink cartridge 40 has a rectangular shape in the X-Y plane, and the width (length in the X-axis direction) is constant in the longitudinal direction (Y-axis direction). For this reason, if the front and rear sides of the ink cartridge 40 are reversed, the ink cartridge 40 can be inserted into a storage compartment inside the lower unit 3.

When the user mounts the ink cartridge 40 in the lower unit 3 in a wrong orientation by mistake, it is possible that the lower side protrusion 40c of the ink cartridge 40 contacts the position detection sensor 18 and the position detection sensor 18 may be damaged. Thus, the position detection sensor 18 is a protection target that is easily damaged with contact with another component and to be protected from contact.

As illustrated in FIG. 12, the sensor protection film 180 is disposed above the position detection sensor 18. The sensor protection film 180 is a flexible film member that prevents foreign matters from adhering to the position detection sensor 18. Therefore, when the ink cartridge 40 contacts the position detection sensor 18 sandwiching the sensor protection film 180 therebetween, the sensor protection film 180 does not have the rigidity to prevent the damage of the position detection sensor 18.

A cover member with a high degree of rigidity may be disposed to cover the top of the position detection sensor 18 to prevent the ink cartridge 40 from contacting the position detection sensor 18. However, when the cover member with high rigidity is provided, the ink cartridge 40 in the mounted state is separated from the position detection sensor 18 by the thickness of the cover member in the height direction. As a result, the height of the apparatus body of the handheld printer 1 becomes larger and the component costs may increase.

In the handheld printer 1 according to the present embodiment, upper ends of the first sensor position restriction projection 71 and the second sensor position restriction projection 72 are disposed above, that is, upstream in the mounting direction from an upper end portion 18t (see FIG. 1) of the position detection sensor 18. The first sensor position restriction projection 71 and the second sensor position restriction projection 72 determine the position of the position detection sensor 18 in the horizontal direction.

Owing to this structure, when the user mounts the ink cartridge 40 in the lower unit 3 in a wrong front-back orientation by mistake, the lower side protrusion 40c of the ink cartridge 40 abuts the first sensor position restriction projection 71 and the second sensor position restriction projection 72, as illustrated in FIG. 14. As a result, it is possible to prevent the ink cartridge 40 from contacting the position detection sensor 18 and the position detection sensor 18 from being damaged without disposing a cover member with a high degree of rigidity on the top of the position detection sensor 18.

The handheld printer 1 of the present embodiment has the two sensor position restriction projections 71 and 72. The upper ends of the sensor position restriction projections 71 and 72 are disposed at a higher position than the position detection sensor 18. Even when the number of the sensor position restriction projection disposed higher than the position detection sensor 18, such a single sensor position restriction projection can prevent the ink cartridge 40 from contacting the position detection sensor 18 and absorb the impact. Therefore, the effect of preventing damage to the position detection sensor 18 can be obtained. Further, three or more sensor position restriction projections disposed at a higher position than the position detection sensor 18 can reliably prevent the contact with the position detection sensor 18 even when the user tris to mount the ink cartridge 40 being tilted state in the apparatus body. Therefore, the effect of preventing damage to the position 1 detection sensor 18 can be improved.

Further, as illustrated in FIG. 14, a distance L1 in the Y-axis direction between the first sensor position restriction projection 71 and the second sensor position restriction projection 72 is smaller than an external length L2 of the lower side protrusion 40c of the ink cartridge 40. Such a configuration can prevent the lower side protrusion 40c of the ink cartridge 40 from passing between the first sensor position restriction projection 71 and the second sensor position restriction projection 72 and contacting the position detection sensor 18. Thus, damage to the position detection sensor 18 can be prevented more reliably.

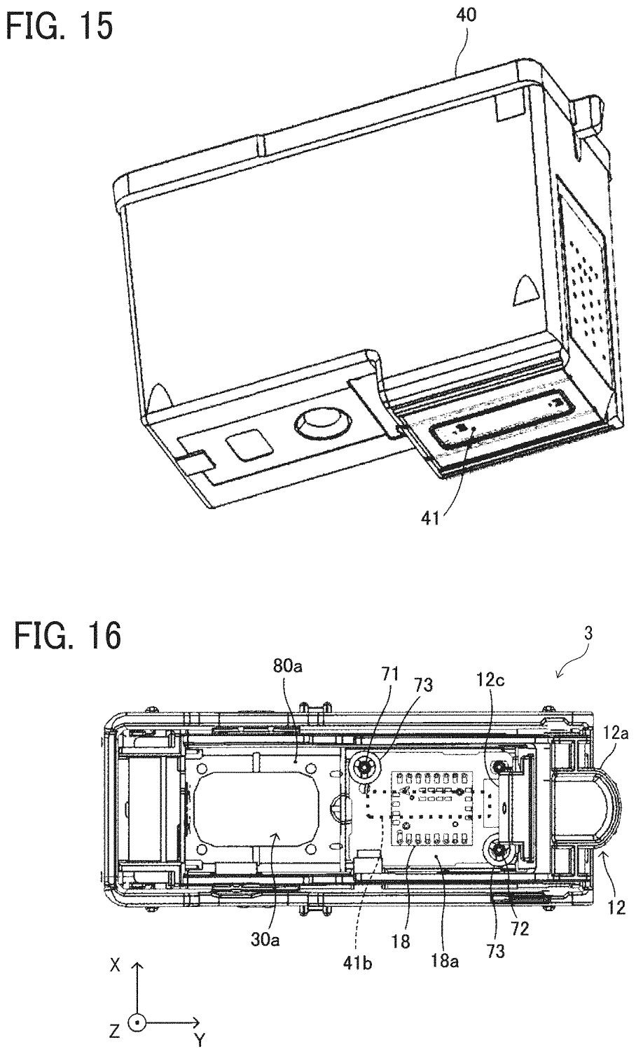

FIG. 15 is a perspective view of the ink cartridge 40, as viewed obliquely from below. FIG. 16 is an explanatory view of the top view of the lower unit 3. A region 41b marked by broken lines is added to the top view illustrated in FIG. 13. The print head 41 of the ink cartridge 40 faces the region 41b when the user tries to mount the ink cartridge into the apparatus body in a reversed front-back orientation in the handheld printer 1.

As illustrated in FIG. 16, the first sensor position restriction projection 71 and the second sensor position restriction projection 72 are positioned in X-Y plane outside the region 41b marked by the broken lines and faced by the print head 41 of the ink cartridge 40 when the ink cartridge 40 is mounted in the reversed front-back orientation.

In a case where the size of the space to accommodate the ink cartridge 40 in the lower unit 3 is larger than that of the ink cartridge 40 in the orthogonal direction to the mounting direction, a backlash may occur when the ink cartridge 40 is mounted in the lower unit 3. The ink cartridge 40 may move in the direction orthogonal to the mounting direction due to the backlash. Therefore, the first sensor position restriction projection 71 and the second sensor position restriction projection 72 are disposed to be positioned outside the region 41b that can face the print head 41 even when the ink cartridge 40 moves in such a direction due to the backlash.

Further, in the handheld printer 1 of the present embodiment, the storage compartment to accommodate the ink cartridge 40 in the lower unit 3 has little or no clearance in the width direction relative to the ink cartridge 40. As a result, there is little or no backlash in the width direction, and when the user mounts the ink cartridge 40 in the reversed front-back orientation, the sensor position restriction projections 71 and 72 abut a desired region of the lower side protrusion 40c.

When the user mounts the ink cartridge 40 in the reversed front-back orientation, such an arrangement can prevent the first sensor position restriction projection 71 or the second sensor position restriction projection 72 from contacting the print head 41. This can prevent the print head 41 from being damaged when the user mounts the ink cartridge 40 in the reversed front-back orientation.

Further, the first sensor position restriction projection 71 and the second sensor position restriction projection 72 are positioned at least outside the region 41b that can face the discharge nozzles 41a lined in a row of the print head 41. Such an arrangement can prevent the print head 41 from being damaged when the user mounts the ink cartridge 40 in the reversed front-back orientation.

When the user mounts the ink cartridge 40 in the reversed front-back orientation, the lower side protrusion 40c of the ink cartridge 40 abuts the sensor position restriction projections 71 and 72 and the upper portion of the ink cartridge 40 projects from the lower unit 3, as illustrated in FIG. 14. In this state, the upper unit 2 which is a cover member is not closable, and the user can recognize that the user improperly mounts the upper unit 2. Therefore, such an improper mounting can be prevented.

Variation 1

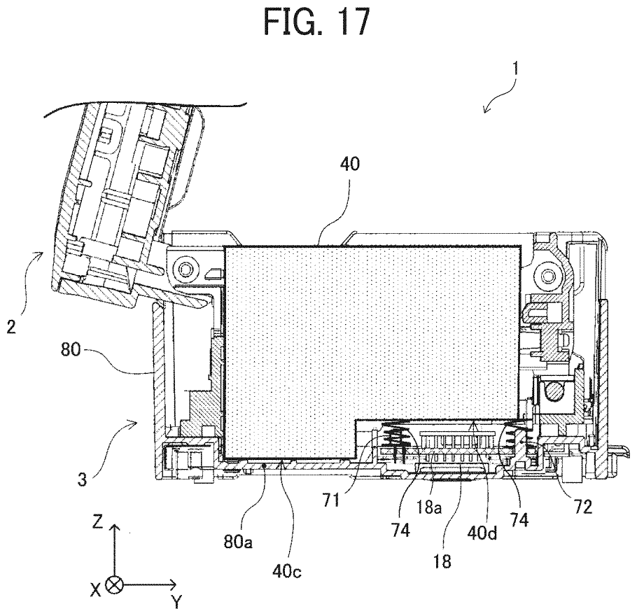

Next, a first variation (hereinafter, referred to as “Variation 1”) of the handheld printer 1 is described below. FIG. 17 is a sectional view of the handheld printer 1 according to Variation 1 in a state in which the upper unit 2 is open and the ink cartridge 40 is mounted.

In the handheld printer 1 according to Variation 1 includes compression springs 74. The compression springs 74 contact an upper side of the sensor substrate 18a of the position detection sensor 18. Upper ends of the compression springs 74 in the state of having a natural length are located higher than the first sensor position restriction projection 71 or the second sensor position restriction projection 72. Variation 1 has a similar configuration as that of the handheld printer 1 of the embodiment described above except that Variation 1 includes the compression springs 74.

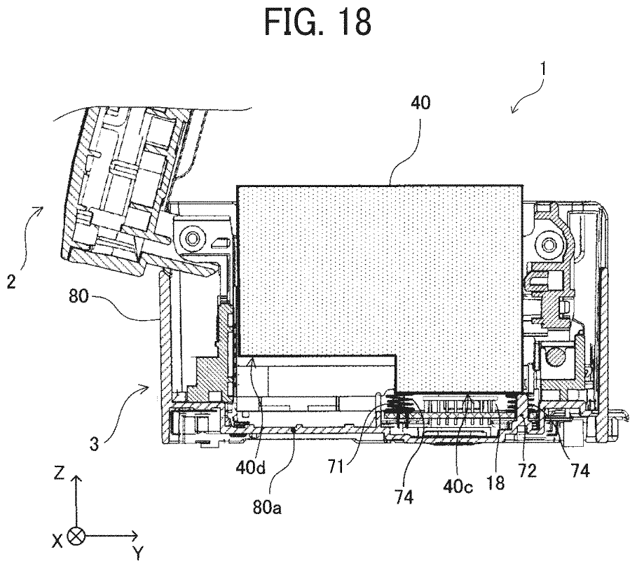

FIG. 17 is a sectional view of the handheld printer 1 according to Variation 1 in a state in which the ink cartridge 40 is mounted into the lower unit 3 in the correct orientation. FIG. 18 is a sectional view of the handheld printer 1 according to Variation 1 in a state in which the ink cartridge 40 is mounted in the lower unit 3 in the reversed front-back orientation.

In Variation 1, when the user mounts the ink cartridge 40 in the reversed orientation, the lower side protrusion 40c of the ink cartridge 40 abuts the compression springs 74. After that, as illustrated in FIG. 18, the bottom of the ink cartridge 40 abuts the first sensor position restriction projection 71 or the second sensor position restriction projection 72 with the compression springs 74 being compressed.

The ink cartridge 40 contacts the compression springs 74 before the ink cartridge 40 contacts the sensor position restriction projections 71 and 72. Thus, the compression springs 74 absorbs the impact caused by mounting operation of the user. As a result, the impact caused when the ink cartridge 40 contacts the sensor position restriction projections 71 and 72 can be reduced and the lower side protrusion 40c of the ink cartridge 40 or the sensor position restriction projections 71 and 72 can be protected from being damaged.

Further, it is desirable that the upper ends of the compression springs 74 in a state of natural length in the vertical direction are positioned above the side recess 40d of the ink cartridge 40 in a state of being properly mounted in the lower unit 3. Owing to such an arrangement, the compression springs 74 are compressed from the state of natural length even when the ink cartridge 40 is mounted in the correct orientation, as illustrated in FIG. 1 and the compression springs 74 pushed by the side recess 40d biases the upper side of the sensor substrate 18a in a downward direction. As a result, the sensor substrate 18a is pressed against an upper side of the housing bottom face 80a and the position of the position detection sensor 18 in the vertical direction can be determined.

Owing to such a configuration provided with the compression springs 74, retaining rings, such as the speed nuts 73 of the above-described embodiment, are not necessary to restrict the movement of the position detection sensor 18 in the vertical direction.

In Variation 1, the compression springs 74 are used as elastic members, but the elastic members are not limited to the compression springs 74, and members made of another elastic material such as a sponge can be used.

Variation 2

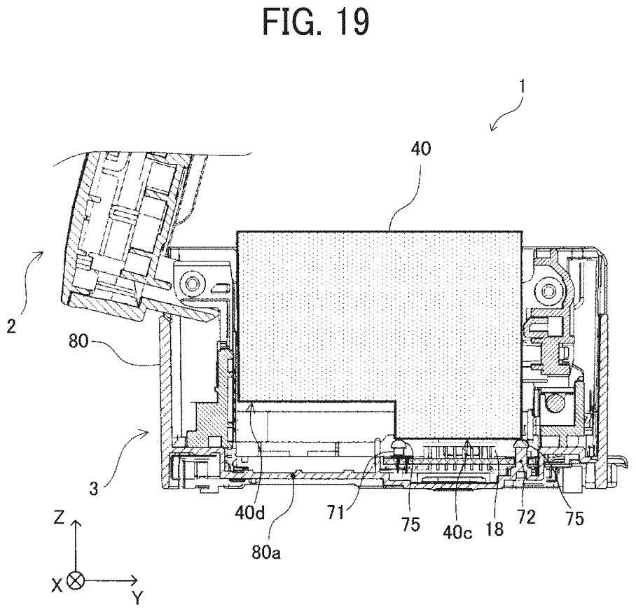

Next, a second variation (hereinafter referred to as “Variation 2 ”) of the handheld printer 1 is described below. FIG. 19 is a sectional view of the handheld printer 1 according to Variation 2 in a state in which the upper unit 2 is open and the ink cartridge 40 is mounted in the lower unit 3 in the reversed front-back orientation.

The handheld printer 1 according to Variation 2 includes protection caps 75 as protectors at upper-end portions of the first sensor position restriction projection 71 and the second sensor position restriction projection 72. Variation 2 has a similar configuration as that of the handheld printer 1 of the embodiment described above except that Variation 2 includes the protection caps 75.

The protection caps 75 can reduce the impact caused by the ink cartridge 40 contacting the first sensor position restriction projection 71 and the second sensor position restriction projection 72 when the user mounts the ink cartridge 40 in the reversed direction. As a result, the lower side protrusion 40c of the ink cartridge 40 or the sensor position restriction projections 71 and 72 can be protected from the damage. Materials such as rubber and sponge can be used for the protection caps 75.

In the above-described embodiment, Variation 1, and Variation 2, descriptions are given for cases where the sensor position restriction projections 71 and 72 serve as contact portions positioned above the position detection sensor 18 and configured to prevent the ink cartridge 40 from impacting the position detection sensor 18.

Such a contact portion may not have the positioning function such as that of the sensor position restriction projections 71 and 72, and the contact portion may be a projection portion that projects in an upward direction from an upper side of the housing bottom face 80a of the housing 80.

Such a contact portion may not be limited to the contact portion that projects in the upward direction from the upper side of the housing bottom face 80a of the housing 80. Alternatively, the contact portion can be any member at least a portion of which is positioned upstream (e.g., the upper side in the examples described above) from the position detection sensor 18 in the mounting direction.

Variation 3

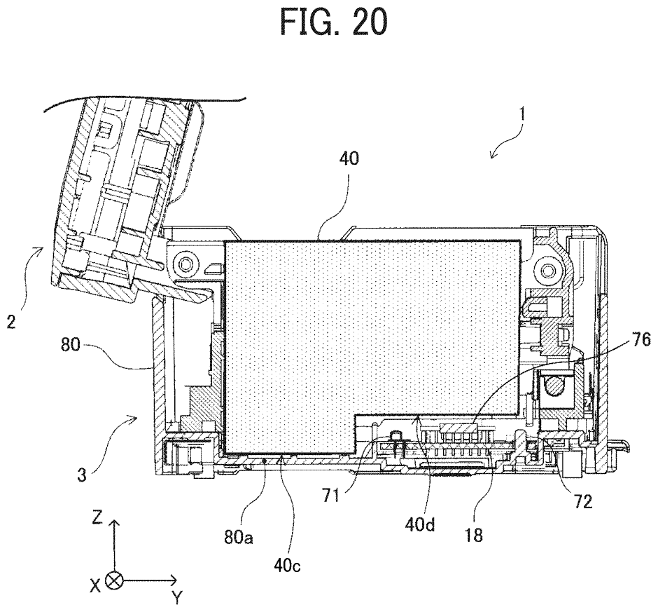

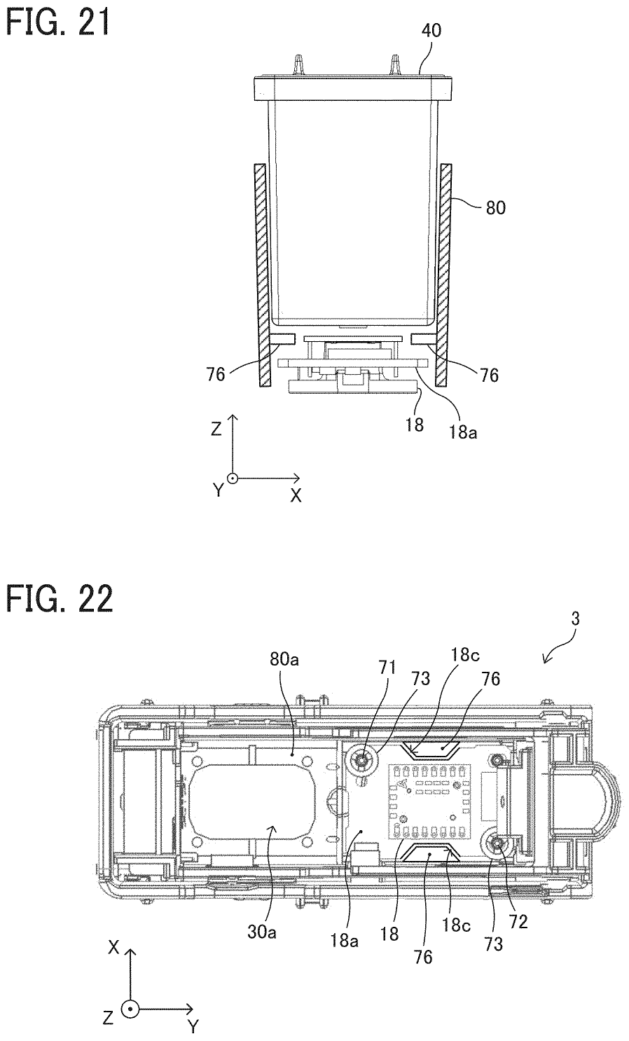

Next, a third variation (hereinafter referred to as “Variation 3 ”) of the handheld printer 1 is described below FIG. 20 is a sectional view of the handheld printer 1 according to Variation 3 in a state in which the upper unit 2 is open and the ink cartridge 40 is mounted, as viewed from the left face 32. FIG. 21 is a sectional view of the handheld printer 1 according to Variation 3, as viewed from the front face 35. FIG. 22 is a top view of the handheld printer 1 according to Variation 3 in a state in which the ink cartridge 40 is not mounted.

The handheld printer 1 according to Variation 3 includes width direction inner projections 76 as contact portions. The width direction inner projections 76 (orthogonal direction projection portions) project inward from an inner wall surface (an inner wall surface of right and left side walls) of the housing 80. Specifically, the width direction inner projections 76 project in a direction orthogonal to the mounting direction toward an inside of the housing 80. Further, the upper end of the first sensor position restriction projection 71 or the second sensor position restriction projection 72 is positioned below the upper end of the position detection sensor 18. Variation 3 has a similar configuration as that of the handheld printer 1 of the embodiment described above except these aspects.

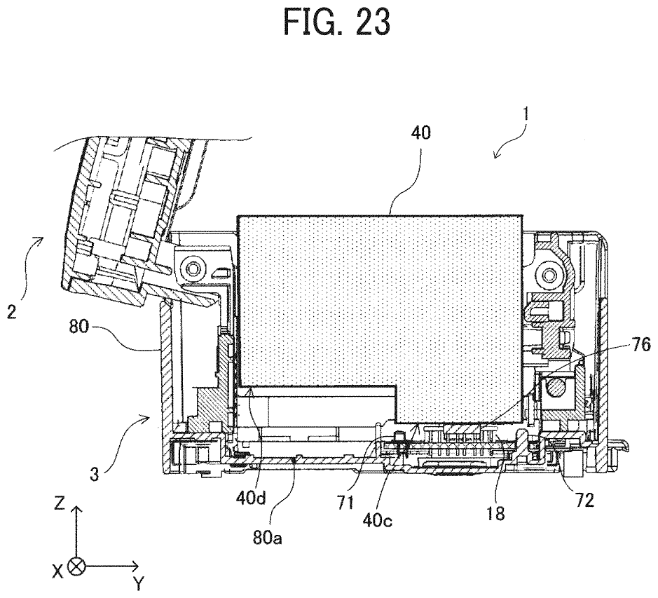

FIGS. 20 and 21 are sectional views of the handheld printer 1 according to Variation 3 in a state in which the ink cartridge 40 is mounted in the lower unit 3 in the correct orientation. FIG. 23 is a sectional view of the handheld printer 1 according to Variation 3 in a state in which the ink cartridge 40 is mounted in the lower unit 3 in the reversed front-back orientation.

In Variation 3, when the user mounts the ink cartridge 40 in the reversed orientation, the lower surface protrusion 40c of the ink cartridge 40 abuts upper sides of the width direction inner projections 76, as illustrated in FIG. 23. As a result, it is possible to prevent the ink cartridge 40 from contacting the position detection sensor 18 and the position detection sensor 18 from being damaged.

As illustrated in FIG. 22, the sensor substrate 18a includes cutout portions 118c. The cutout portions 18c face the crosswise direction inner projections 76 in the vertical direction. Owing to this arrangement, when the position detection sensor 18 is mounted from above the housing 80, the sensor substrate 18a can be mounted without being caught by the width direction inner projections 76.

In the embodiment described above, the position detection sensor 18, as a sensor, has a position detection function for detecting the position of the apparatus and a recording material detection function for detecting the presence or absence of the recording sheet P. However, aspects of the present disclosure are applicable to a configuration in which a position detector and a recording material detector are separately provided, or a configuration in which only the position detector or the recording material detector is provided.

An electronic component disposed at a downstream (downward) position in the mounting direction of the attachment unit is not limited to a sensor component such as the position detection sensor 18 but may be any electronic component such as a controller printed circuit board or the like.

Further, a protected component disposed at a downstream (downward) position in the mounting direction of the attachment unit is not limited to an electronic component but any component such as an optical part such as a lens, a portion with low mechanical strength of a component, or other components which are easily damaged by the contact with the attachment unit.

In the embodiment described above, the description is given for a case where the attachment unit is the ink cartridge 40, but the attachment unit can be any unit attachable to and removable from the apparatus body of the handheld printer 1.

Although descriptions have been made as above of the examples in which aspects of the present disclosure are applied to the inkjet handheld printer 1 in the above-described embodiment, the aspects of the present disclosure can also be applied to other types of image forming apparatuses. The aspects of the present disclosure can be applied to a recording apparatus of, for example, thermal type or thermal-transfer type.

The above descriptions are examples, and specific effects can be achieved with each of the following aspects.

Aspect 1

A mobile image forming apparatus such as the handheld printer 1 includes a recording device such as the print head 41 to record an image on a recording material such as the recording paper P; and an apparatus main body such as the lower unit 3 to contain the recording device. The mobile image forming apparatus further includes an attachment unit to be attachable to and removable from the apparatus body, and a protection target such as the position detection sensor 18 disposed downstream (such as the lower side), in the mounting direction of the attachment unit such as the ink cartridge 40, from the attachment unit being attached to the apparatus main body; and a contact portion such as the first sensor position restriction projection 71 and the second sensor position restriction projection 72, and at least a part of the contact portion is positioned upstream (upper side or the like) from the protection target in the mounting direction.

According to this, when the user tries to mount the attachment unit at the mounting position in a posture that the attachment unit abuts the protection target disposed at the downstream position in the mounting direction, the attachment unit abuts the contact portion disposed at the upstream position in the mounting direction before the attachment unit reaches the protection target. As a result, it is possible to prevent the attachment unit from contacting the protection target, and to prevent the protection target from being damaged by the impact caused by the contact of the attachment unit when the user tries to mount the attachment unit in a wrong orientation or mount a wrong type of attachment unit in the apparatus body.

Aspect 2

In Aspect 1, the contact portion is a projection, such as the sensor position restricting projections 71 and 72, protrudes from an inner wall surface on the downstream side in the mounting direction (an upper surface of the housing bottom face 80a, etc.) of the apparatus body to an upstream side in the mounting direction.

According to this, since the projection as a part of the apparatus body serves as the contact portion, there is no need to provide another member as a contact portion. Therefore, it is possible to simplify the configuration of the apparatus.

Aspect 3

In Aspect 2, the projection has a function (horizontal direction positioning function, etc.) to determine the position of the protection target relative to the apparatus body in a direction (horizontal direction, etc.) orthogonal to the mounting direction protection target.

According to this, since the contact portion has the function to determine the position in the orthogonal direction, there is no need to provide another member as the contact portion. Therefore, it is possible to simplify the configuration of the apparatus.

Aspect 4

In any one of Aspects 1 through 3, the contact portion is a projection, such as the width direction inner projections 76, that projects in the orthogonal direction. The projection as the contact portion protrudes from the inner wall surface (the inner wall surface of right and left side walls, etc.) positioned orthogonal to the mounting direction of the apparatus body to the inside (inside of width direction, etc.).

According to this, as described in the above-mentioned Variation 3, it is possible to cause the attachment unit to abut the contact portion, which protrudes in the orthogonal direction and is disposed upstream in the mounting direction, before the attachment unit reaches the protection target. As a result, it is possible to prevent the protection target from being damaged by the impact caused by the contact of the attachment unit when the user tries to mount the attachment unit in a wrong direction or mount a wrong type of attachment unit relative to the apparatus body.

Aspect 5

In any one of Aspects 1 through 4, a downstream side of the ink cartridge 40 in the mounting direction of the attachment unit includes a projection such as the lower side protrusion 40c projecting in the mounting direction and a recess such as the lower side recess 40d recessed from the projection to the upstream side in the mounting direction. The protection target is positioned downstream in the mounting direction from the recess of the attachment unit being mounted in the apparatus body.

As a result, it is possible to reduce the distance between the attachment unit and the protection target as close as possible and the apparatus size in the mounting direction.

Aspect 6

In Aspect 5, the apparatus body includes a plurality of contact portions. The plurality of contact portions includes a first contact portion, such as the first sensor position restriction projection 71, and a second contact portion, such as the second sensor position restriction projection 72, disposed at a distance from each other in an arrangement direction (e.g., the Y-axis direction) orthogonal to the mounting direction. The distance (e.g., the distance L1) between the first contact portion and the second contact portion in the arrangement direction thereof (e.g., the Y-axis direction) is shorter than the length (e.g., the external length L2) of the projection of the projection in the arrangement direction.

As a result, it is possible to prevent the projection from slipping through the gap between the two contact portions and contacting the protection target and to prevent the protection target from being damaged.

Aspect 7

In any one of Aspects 1 to 5, the apparatus includes a plurality of the contact portions such as the sensor position restricting projections 71 and 72.

This aspect can increase the possibility that the attachment unit contacts the contact portions when the user tries to mount the attachment unit in a wrong orientation or mount a wrong type of attachment unit relative to the apparatus body. Thus, the advantageous effect of preventing the protection target from being damaged by the contact of the attachment unit is improved.

Aspect 8

In any one of Aspects 1 to 7, the attachment unit includes the recording device, and the recording device includes a discharge outlet such as the discharge nozzles 41a that discharges an image forming substance. The attachment unit is mounted at a position such that the recording device does not face the protection target. The contact portion is disposed not to face the discharge outlet when the attachment unit is mounted in a posture where the recording device faces the protection target.

As a result, it is possible to prevent the protection target from being damaged by the impact caused by the attachment unit contacting the contact portions when the user tries to mount the attachment unit in a wrong orientation or mount a wrong type of attachment unit relative to the apparatus body.

Aspect 9

In any one of Aspects 1 through 8, the apparatus includes an elastic member such as compression springs 74. The elastic member contacts an upstream face (such as the upper face of the sensor substrate 18a, etc.) of the protection target in the mounting direction, and an upstream end of the elastic member in the mounting direction is positioned upstream from the contact portions in the mounting direction when the elastic member has a natural length.

According to this, when the user tries to mount the attachment unit in a wrong orientation or mount a wrong type of the attachment unit relative to the apparatus body, the attachment unit contacts the elastic member before the attachment unit contacts the contact portion. As a result, the impact can be mitigated when the attachment unit contacts the contact portions, and the damage to the attachment unit and the contact portions can be prevented.

Aspect 10

In any one of Aspects 1 to 9, the apparatus includes a protector such as the protection caps 75. The protector is disposed on the upstream end (the upper end) of the contact portion in the mounting direction.

As a result, it is possible to mitigate the impact when the attachment unit contacts the contact portion and prevent the damage to the attachment unit and the contact portions when the user tries to mount the attachment unit in a wrong orientation, or a wrong type of attachment unit is mounted in the apparatus body.

Aspect 11

In any one of Aspects 1 to 9, the protection target is a sensor such as the position detection sensor 18 and the like. The sensor being the protection target has at least one of a position detection function to detect the position of the apparatus or as a recording medium detection function to detect the presence or absence of a recording medium.

As a result, it is possible to prevent the sensor from being damaged by the impact caused by the contact of the attachment unit when the user tries to mount the attachment unit in a wrong orientation or mount a wrong type of attachment unit relative to the apparatus body.

Aspect 12

Aspect 12 concerns an apparatus body (e.g., the lower unit 3) of a mobile image forming apparatus such as the handheld printer 1 in which a recording device such as the print head 41 to record an image on a recording medium such as the recording paper P is detachably mounted. The apparatus body includes an a attachment unit mount such as the lower unit 3 to contain an attachable and detachable attachment unit such as the ink cartridge 40; a protection target such as the position detection sensor 18 disposed downstream (such as the lower side), in the mounting direction of the attachment unit, from the attachment unit mounted in the apparatus body; and a contact portion such as the first sensor position restriction projection 71 and the second sensor position restriction projection 72. At least a part of the contact portion is positioned upstream (upper side or the like) in the mounting direction from the protection target.

According to this, similarly as the above-described Aspect 1, it is possible to prevent the protection target from being damaged by the impact caused by the contact of the attachment unit when the user tries to mount the attachment unit in a wrong orientation or mount a wrong type of attachment unit relative to the apparatus body.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. An image forming apparatus comprising:
a recording device configured to record an image on a recording medium;
an apparatus body configured to house the recording device;
an attachment unit configured to be removably mounted in the apparatus body;
a protection target disposed downstream, in a mounting direction of the attachment unit, from a mounting position of the attachment unit in the apparatus body; and
a contact portion at least a part of which is positioned upstream from the protection target in the mounting direction.

2. The image forming apparatus according to claim 1,
wherein the contact portion is a projection protruding from a downstream inner wall surface of the apparatus body in the mounting direction, the projection protruding upstream in the mounting direction.

3. The image forming apparatus according to claim 2,
wherein the projection is configured to determine a position of the protection target relative to the apparatus body in a direction orthogonal to the mounting direction.

4. The image forming apparatus according to claim 1,
wherein the contact portion is a projection internally protruding from an inner wall surface of the apparatus body in a direction orthogonal to the mounting direction to an inside of the apparatus body.

5. The image forming apparatus according to claim 1;
wherein a downstream side of the attachment unit in the mounting direction includes:
a projection protruding in the mounting direction; and
a recess recessed from the projection to an upstream side in the mounting direction, and
wherein the protection target is positioned downstream in the mounting direction from the recess in a state where the attachment unit is mounted in the apparatus body.

6. The image forming apparatus according to claim 5,
wherein the contact portion is one of a plurality of contact portions including:
a first contact portion; and
a second contact portion disposed at a distance from the first contact portion in an arrangement direction orthogonal to the mounting direction, and
wherein the distance between the first contact portion and the second contact portion in the arrangement direction is shorter than a length of the projection in the arrangement direction.

7. The image forming apparatus according to claim 1, wherein the contact portion is one of a plurality of contact portions.

8. The image forming apparatus according to claim 1,
wherein the attachment unit includes the recording device,
wherein the recording device includes a discharge outlet configured to discharge an image forming substance,
wherein the apparatus body is configured to house the attachment unit at a position where the recording device does not face the protection target, and
wherein the contact portion is disposed not to face the discharge outlet when the attachment unit in the apparatus body is in a posture that the recording device faces the protection target.

9. The image forming apparatus according to claim 1, further comprising an elastic member configured to contact an upstream surface of the protection target in the mounting direction, and
wherein, in a state where the elastic member has a natural length, an upstream end of the elastic member is positioned upstream from the contact portion in the mounting direction.

10. The image forming apparatus according to claim 1, further comprising a protector disposed at an upstream end of the contact portion in the mounting direction.

11. The image forming apparatus according to claim 1,
wherein the protection target is a sensor having at least one of a position detection function to detect a position of the image forming apparatus and a recording medium detection function to detect a presence or absence of the recording medium.

12. An apparatus body of an image forming apparatus to which a recording device configured to record an image on a recording medium is removably mounted, the apparatus body comprising:
an attachment unit mount to which an attachment unit is removably mounted,
a protection target disposed downstream, in a mounting direction of the attachment unit, from a mounting position of the attachment unit in the apparatus body, and
a contact portion at least a part of which is positioned upstream from the protection target in the mounting direction.
